(19) United States
(12) Patent Application Publication
(10) Pub. No.: US 2023/0235916 A1
(43) Pub. Date: Jul. 27, 2023

(54) TOTAL HEAT EXCHANGE ELEMENT AND VENTILATOR

(71) Applicant: Mitsubishi Electric Corporation, Chiyoda-ku, Tokyo (JP)

(72) Inventors: Xin WANG, Tokyo (JP); Hajime SOTOKAWA, Tokyo (JP)

(73) Assignee: Mitsubishi Electric Corporation, Chiyoda-ku, Tokyo (JP)

(21) Appl. No.: 18/001,891

(22) PCT Filed: Aug. 11, 2020
(86) PCT No.: PCT/JP2020/030615

§ 371 Date: Dec. 15, 2022

(51) Int. Cl. F24F 12/00

(52) U.S. Cl. CPC F24F 12/006; F28D 9/0025

(57) ABSTRACT

A total heat exchange element includes partition plates, and spacers shaped into a corrugated shape in which a plurality of apexes are connected by side walls, the partition plates and the spacers being stacked such that extending directions of the plurality of apexes intersect between the spacers adjacent to each other. A plurality of flow paths include flow paths each having a shape which is line-symmetrical with respect to a straight line extending in the stacking direction, and flow paths each having a shape which is not line-symmetrical with respect to a straight line extending in the stacking direction. The length of the side walls constituting the flow paths each having a shape which is not line-symmetrical is longer than the length of the side walls constituting the flow paths having a shape which is line-symmetrical.

### FIELD

The present disclosure relates to a total heat exchange element that performs total heat exchange between air flows, and a ventilator.

### BACKGROUND

In a case where a person is present in a room in a building, air pollutants derived from a human body, a building material, and the like, are diffused. Therefore, replacement of indoor air with outdoor air performed by a ventilation fan or the like is essential for ensuring human health and comfortability, but in a period of time in which cooling or heating is needed, it is also important to ensure a thermal environment by an air conditioner or the like in addition to indoor air quality. In order to simultaneously ensure heat and humidity environments in the room by ensuring indoor air quality by ventilation, and by temperature control by air conditioning or humidity control by a humidifier-dehumidifier, mechanical ventilation including simultaneous air supply and air exhaust, and total heat recovery through a total heat exchange element are simultaneously performed by a total heat exchange ventilation fan. Consequently, it is possible to reduce air-conditioning energy in a period of time in which cooling or heating is needed, and to maintain air quality in a comfortable state.

Among indices for determining performance of such a total heat exchange ventilation fan, there is total heat exchange efficiency which is exchange efficiency of total heat obtained by combining sensible heat and latent heat in indoor and outdoor air, and improvement of the total heat exchange efficiency is important for ventilation and air conditioning which achieve both comfortability and an energy saving property. Patent Literature 1 discloses a total heat exchange element including partition plates and spacing plates that maintain an interval between the partition plates, in which the partition plates and the spacing plates are bonded with an adhesive. The total heat exchange element described in Patent Literature 1 is manufactured by: applying an adhesive to apexes of the spacing plate having a corrugated cross section; bonding the spacing plate and the partition plate to be integrated to form each of unit components; then applying the adhesive to a spacing plate side of each of the unit components; and stacking the unit components to form a plurality of layers thereof such that extending directions of the apexes of the spacing plates are orthogonal to each other between the unit components adjacent in a stacking direction. Consequently, in the total heat exchange element, first laminar air flow paths and second laminar air flow paths orthogonal to the first laminar air flow paths are alternately formed by the partition plates and the spacing plates in the stacking direction of the partition plates. Then, latent heat and sensible heat are exchanged between first air flowing through the first laminar air flow paths and second air flowing through the second laminar air flow paths using each of the partition plates as a medium.

### CITATION LIST

### Patent Literature

Patent Literature 1: Japanese Patent Application Laid-open No. 2009-250585

### SUMMARY

### Technical Problem

The total heat exchange element described in Patent Literature 1 is required to have strength for maintaining the shapes of the first laminar air flow paths and the second laminar air flow paths, and in each unit component, the spacing plate needs to be bonded to the partition plate at a large number of bonding portions. However, an adhesive is present at the bonding portions between the partition plate and the spacing plate, which reduces moisture permeability, and thereby humidity exchange efficiency is reduced. That is, the total heat exchange efficiency decreases as the number of bonding portions increases, which is a problem. When the number of bonding portions between the partition plate and the spacing plate is decreased, the humidity exchange efficiency is improved, but there is a possibility that strength for maintaining the shapes of the first laminar air flow paths and the second laminar air flow paths cannot be ensured. That is, there is a demand for a heat exchange element capable of decreasing the number of bonding portions between a partition plate and a spacing plate as compared with conventional ones while ensuring strength of the heat exchange element.

The present disclosure has been made in view of the above, and an object thereof is to obtain a total heat exchange element capable of improving humidity exchange efficiency as compared with conventional ones while ensuring strength for maintaining the shapes of air flow paths.

### Solution to Problem

In order to solve the above-described problem and achieve the object, a total heat exchange element of the present disclosure includes partition plates, and spacers shaped into a corrugated shape in which a plurality of apexes including recesses and protrusions are connected by side walls, the partition plates and the spacers being stacked such that extending directions of the plurality of apexes intersect between the spacers adjacent to each other. The total heat exchange element includes, between two of the partition plates adjacent in the stacking direction, a plurality of flow paths surrounded by the partition plates and the side walls. The plurality of flow paths include flow paths each having a shape which is line-symmetrical with respect to a straight line extending in the stacking direction, and flow paths each having a shape which is not line-symmetrical with respect to a straight line extending in the stacking direction. The length of the side walls constituting the flow paths each having a shape which is not line-symmetrical is longer than the length of the side walls constituting the flow paths each having a shape which is line-symmetrical.

### Advantageous Effects of Invention

The total heat exchange element according to the present disclosure achieves an effect that it is possible to improve humidity exchange efficiency as compared with conventional ones while ensuring strength for maintaining the shapes of air flow paths.

### BRIEF DESCRIPTION OF DRAWINGS

FIG. 1 is a perspective view schematically illustrating an example of a configuration of a total heat exchange element according to a first embodiment.

FIG. 2 is an enlarged perspective view of a part of the configuration of the total heat exchange element according to the first embodiment.

FIG. 3 is a perspective view illustrating an example of the appearance of a unit component in the total heat exchange element according to the first embodiment.

FIG. 4 is a cross-sectional view schematically illustrating an example of a configuration of a first intra-element air flow path of the total heat exchange element according to the first embodiment.

FIG. 5 is a cross-sectional view schematically illustrating an example of a configuration of a second intra-element air flow path of the total heat exchange element according to the first embodiment.

FIG. 6 is a cross-sectional view schematically illustrating another example of a configuration of an air flow path of the total heat exchange element according to the first embodiment.

FIG. 7 is a cross-sectional view schematically illustrating another example of a configuration of an air flow path of the total heat exchange element according to the first embodiment.

FIG. 8 is a diagram illustrating an example of a relationship between pressure loss and an angle formed between a lower base and a leg of a trapezoid in each of a flow path having a bilaterally symmetrical trapezoidal shape and a flow path having a bilaterally asymmetrical trapezoidal shape.

FIG. 9 is a view schematically illustrating an example of a configuration of a ventilator according to the first embodiment.

### DESCRIPTION OF EMBODIMENTS

Hereinafter, a total heat exchange element and a ventilator according to an embodiment of the present disclosure will be described in detail with reference to the drawings.

### First Embodiment

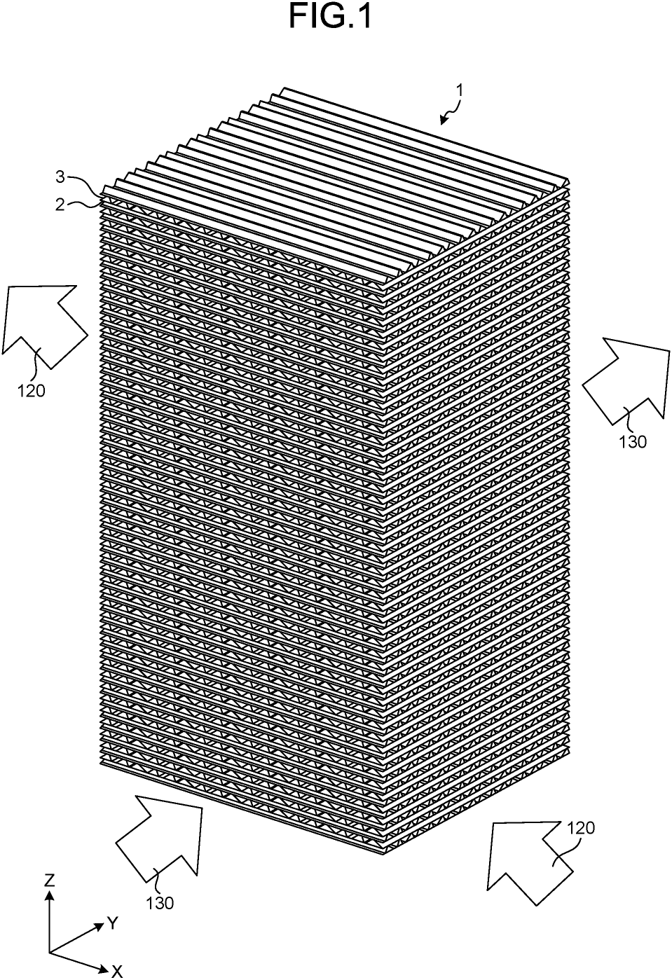

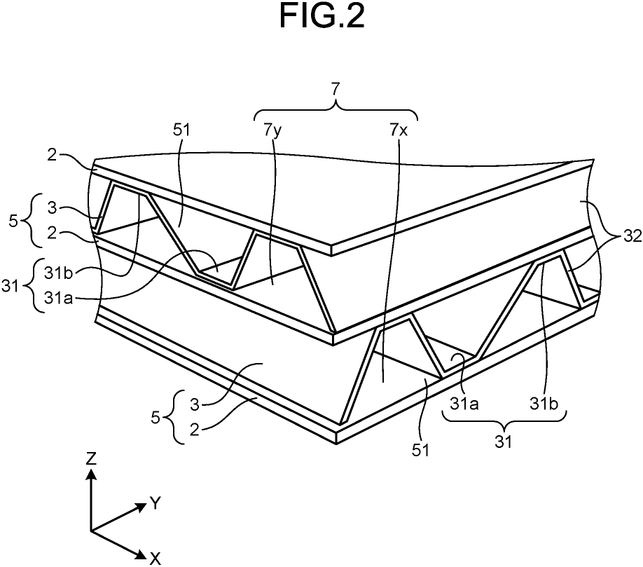

FIG. 1 is a perspective view schematically illustrating an example of a configuration of a total heat exchange element according to a first embodiment. FIG. 2 is an enlarged perspective view of a part of the configuration of the total heat exchange element according to the first embodiment. As illustrated in FIGS. 1 and 2, directions each of which is parallel to one of two mutually orthogonal sides of a partition plate 2 having a square shape are defined as an X direction and a Y direction, and a direction orthogonal to both the X direction and the Y direction is defined as a Z direction. Hereinafter, a relative positional relationship in the Z direction may be expressed using “upper” or “lower”. A total heat exchange element 1 includes partition plates 2 and spacers 3 that space the partition plates 2.

The partition plate 2 is a plate-like member having moisture permeability which is a property of being permeable to water vapor but being impermeable to air, and a gas shielding property which is a property of isolating a supply air flow and an exhaust air flow to be described later. The partition plate 2 has a square shape in one example.

The spacer 3 is a member shaped into a corrugated shape in which recesses 31a as valley portions and protrusions 31b as crest portions are alternately continued. The recesses 31a and the protrusions 31b extend in the X direction or the Y direction. The recesses 31a of the spacer 3 are bonded to the partition plate 2 on a lower side with an adhesive, and the protrusions 31b thereof are bonded to the partition plate 2 on an upper side with the adhesive. Hereinafter, in a case where it is not necessary to distinguish between the recess 31a and the protrusion 31b of the spacer 3, the recess 31a and the protrusion 31b are each referred to as an apex 31. The apex 31 is a portion in contact with the partition plate 2 via the adhesive. A surface connecting the apexes 31 adjacent to each other in an alignment direction of a plurality of apexes 31, that is, a surface connecting a bottom portion of the recess 31a and a top portion of the protrusion 31b is referred to as a side wall 32. That is, the spacer 3 has a structure in which the apex 31 and the apex 31 are connected by the side wall 32. In the examples of FIGS. 1 and 2, the apex 31 and the side wall 32 each have a planar shape. The dimension of the spacer 3 in an XY plane is the same as the dimension of the partition plate 2.

Here, a resultant obtained by bonding and integrating the partition plate 2 and the spacer 3 in which the adhesive is applied to a lower surface of each recess 31a which is the apex 31 is referred to as a unit component 5. In the unit component 5, the lower surface of each recess 31a of the spacer 3 is bonded to an upper surface of the partition plate 2 via the adhesive over the extending direction of the recess 31a. Consequently, the unit component 5 is formed into a three-dimensional structure having a square bottom surface. In the unit component 5, corrugated portions of the spacer 3 are arranged on a pair of sides parallel to each other of the partition plate 2 having a square shape, and the side walls 32 of the spacer 3 are arranged on the other pair of sides parallel to each other. Hereinafter, a portion of the unit component 5 where the corrugated portion is arranged to be exposed to the outside is referred to as a ventilation surface 51.

As illustrated in FIGS. 1 and 2, the total heat exchange element 1 has a structure in which the unit components 5 are stacked in the Z direction such that the ventilation surfaces 51 of the unit components 5 adjacent in the Z direction do not face the same direction. That is, the total heat exchange element 1 has a structure in which the unit components 5 are stacked in the Z direction, each of the unit components 5 being rotated by 90 degrees in the XY plane with respect to the unit component 5 immediately therebelow. At that time, the adhesive is applied to upper surfaces of the protrusions 31b of the spacer 3 of the unit component 5, and the upper surfaces are bonded to a lower surface of the partition plate 2 of the unit component 5 arranged on an upper side.

Consequently, a plurality of flow paths surrounded by the partition plates 2 and the side walls 32 are formed between two partition plates 2 adjacent in the Z direction which is a stacking direction. That is, when attention is paid to the pair of partition plates 2 adjacent in the Z direction and the spacer 3 sandwiched between the pair of partition plates 2, a flow path is formed which is surrounded by the apex 31, the two side walls 32 adjacent to the apex 31, and the partition plate 2 facing the apex 31. An air flow, which is a flow of air, flows through the flow path. In the present description, a plurality of flow paths formed between two partition plates 2 adjacent in the Z direction are collectively referred to as an intra-element air flow path 7.

As described above, in the total heat exchange element 1, the unit components 5 are stacked in the Z direction in a state where each of the unit components 5 being rotated by 90 degrees in the XY plane with respect to the unit component 5 immediately therebelow. As a result, a first intra-element air flow path 7x which is the intra-element air flow path 7 extending in the X direction, and a second intra-element air flow path 7y which is the intra-element air flow path 7 extending in the Y direction are alternately stacked. A first air flow 120 is caused to flow through the first intra-element air flow path 7x and a second air flow 130 is caused to flow through the second intra-element air flow path 7y, and thereby latent heat and sensible heat are exchanged between the first air flow 120 and the second air flow 130 using the partition plate 2 as a medium. Hereinafter, in a case where it is not necessary to distinguish between the first intra-element air flow path 7x and the second intra-element air flow path 7y, each thereof is referred to as the intra-element air flow path 7.

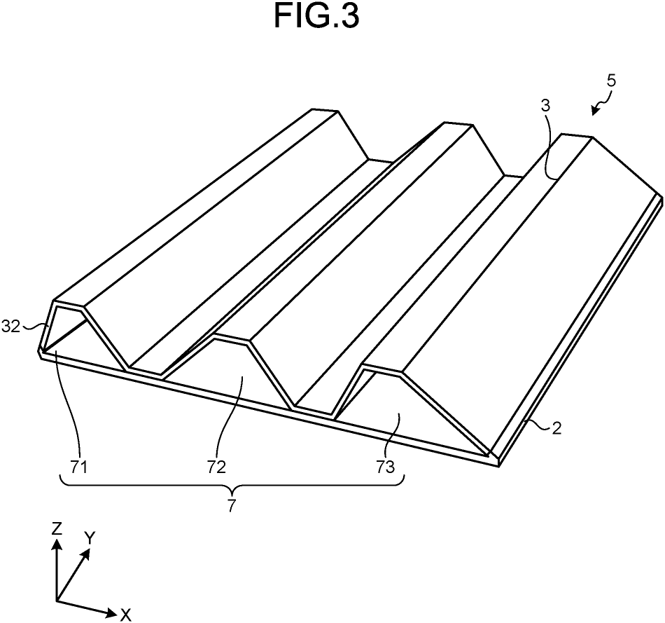

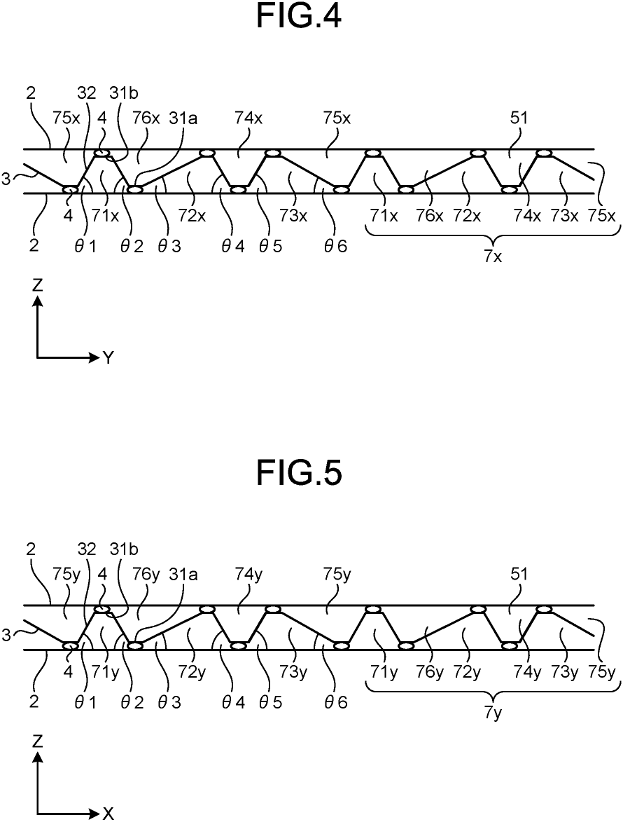

Next, the shape of the spacer 3 will be described in detail. FIG. 3 is a perspective view illustrating an example of the appearance of the unit component in the total heat exchange element according to the first embodiment. FIG. 4 is a cross-sectional view schematically illustrating an example of a configuration of the first intra-element air flow path of the total heat exchange element according to the first embodiment, and FIG. 5 is a cross-sectional view schematically illustrating an example of a configuration of the second intra-element air flow path of the total heat exchange element according to the first embodiment. FIGS. 4 and 5 each illustrate the spacer 3 sandwiched between a pair of partition plates 2 arranged in the Z direction. FIG. 4 illustrates the ventilation surface 51 perpendicular to the X direction, and FIG. 5 illustrates the ventilation surface 51 perpendicular to the Y direction. In the following description, a direction in which the apexes 31 are aligned in a cross section perpendicular to the intra-element air flow path 7 is referred to as a left-right direction.

As illustrated in FIG. 3, the spacer 3 is shaped such that, in the cross section perpendicular to the intra-element air flow path 7, a flow path 71 having a bilaterally symmetrical trapezoidal shape and flow paths 72 and 73 each having a bilaterally asymmetrical trapezoidal shape are aligned in the left-right direction. More specifically, the bilaterally symmetrical trapezoidal shape indicates a trapezoidal shape which is line-symmetrical with respect to a straight line parallel to the stacking direction, that is, the Z direction in the cross section perpendicular to the intra-element air flow path 7. In addition, the bilaterally asymmetrical trapezoidal shape indicates a trapezoidal shape which is not line-symmetrical with respect to a straight line parallel to the Z direction in the cross section perpendicular to the intra-element air flow path 7. The flow path 71 having a bilaterally symmetrical trapezoidal shape corresponds to a flow path having a shape which is line-symmetrical with respect to a straight line extending in the stacking direction, and the flow paths 72 and 73 each having a bilaterally asymmetrical trapezoidal shape correspond to flow paths each having a shape which is not line-symmetrical with respect to a straight line extending in the stacking direction. In one example, shaping of the spacers 3 is performed by bending a plate-like member.

A ratio of the flow path 71 having a bilaterally symmetrical trapezoidal shape to the flow paths 72 and 73 each having a bilaterally asymmetrical trapezoidal shape is determined in advance by experiment or calculation so as to have strength capable of maintaining the shapes of the flow paths 71, 72, and 73 when a predetermined number of unit components 5 are stacked in the Z direction. The ratio between the flow path 71 having a bilaterally symmetrical trapezoidal shape and the flow paths 72 and 73 each having a bilaterally asymmetrical trapezoidal shape which provide strength capable of maintaining the shapes of the flow paths 71, 72, and 73 may vary depending on an angle of the side wall 32 with respect to the partition plate 2 in the flow path 71 having a bilaterally symmetrical trapezoidal shape. In a case where the ratio of the flow path 71 having a bilaterally symmetrical trapezoidal shape and the angle of the side wall 32 with respect to the partition plate 2 in the flow path 71 having a bilaterally symmetrical trapezoidal shape do not satisfy predetermined conditions, there is a possibility that the spacer 3 cannot maintain the shapes of the flow paths 71, 72, and 73, and is crushed. In one example, if the ratio of the flow path 71 having a bilaterally symmetrical trapezoidal shape is too small, there is a possibility that the shapes of the flow paths 71, 72, and 73 cannot be maintained, and therefore, the ratio of the bilaterally symmetrical trapezoidal shape is desirably a predetermined value or more.

As illustrated in FIGS. 4 and 5, two partition plates 2 are arranged in parallel at an interval in the Z direction with the spacer 3 interposed therebetween. A space surrounded by the two partition plates 2 is the first intra-element air flow path 7x or the second intra-element air flow path 7y.

In the example of FIG. 4, regarding the spacer 3, shaping of the spacer 3 is performed so as to form a flow path 71x having an isosceles trapezoidal shape including legs of equal length, and flow paths 72x and 73x each having a bilaterally asymmetrical trapezoidal shape including a leg the length of which is equal to that of the leg of the flow path 71x having an isosceles trapezoidal shape and a leg longer than the leg of the flow path 71x having an isosceles trapezoidal shape in a cross section perpendicular to the first intra-element air flow path 7x. The flow paths 72x and 73x each having a bilaterally asymmetrical trapezoidal shape are arranged such that the longer legs of the flow paths 72x and 73x each having a bilaterally asymmetrical trapezoidal shape are arranged on a side of the flow path 71x having an isosceles trapezoidal shape.

Consequently, the flow paths 71x, 72x, and 73x are formed between the spacer 3 and the partition plate 2 on a lower side, and in addition, flow paths 74x, 75x, and 76x obtained by respectively inverting the shapes of the flow paths 71x, 72x, and 73x in the vertical direction are formed between the spacer 3 and the partition plate 2 on an upper side.

As a result, as illustrated in FIG. 4, by the spacer 3 and the two partition plates 2 sandwiching the spacer 3, the first intra-element air flow path 7x is constituted with the flow paths 71x, 72x, 73x, 74x, 75x, and 76x having different shapes, and the flow paths 71x, 76x, 72x, 74x, 73x, and 75x are sequentially and consecutively provided.

The second intra-element air flow path 7y is similar to the first intra-element air flow path 7x. As illustrated in FIG. 5, regarding the spacer 3, shaping of the spacer 3 is performed so as to form a flow path 71y having an isosceles trapezoidal shape including legs of equal length, and flow paths 72y and 73y each having a bilaterally asymmetrical trapezoidal shape including a leg the length of which is equal to that of the leg of the flow path 71y having an isosceles trapezoidal shape and a leg longer than that of the flow path 71y having an isosceles trapezoidal shape in a cross section perpendicular to the second intra-element air flow path 7y. The flow paths 72y and 73y each having a bilaterally asymmetrical trapezoidal shape are arranged such that the longer legs of the flow paths 72y and 73y each having a bilaterally asymmetrical trapezoidal shape are arranged on a side of the flow path 71y having an isosceles trapezoidal shape.

Consequently, the flow paths 71y, 72y, and 73y are formed between the spacer 3 and the partition plate 2 on a lower side, and in addition, flow paths 74y, 75y, and 76y obtained by respectively inverting the shapes of the flow paths 71y, 72y, and 73y in the vertical direction are formed between the spacer 3 and the partition plate 2 on an upper side.

As a result, as illustrated in FIG. 5, by the spacer 3 and the two partition plates 2 sandwiching the spacer 3, the second intra-element air flow path 7y is constituted with the flow paths 71y, 72y, 73y, 74y, 75y, and 76y having different shapes, and the flow paths 71y, 76y, 72y, 74y, 73y, and 75y are sequentially and consecutively provided.

The shapes of the flow paths 74x, 75x, and 76x, among the flow paths 71x, 72x, 73x, 74x, 75x, and 76x constituting the first intra-element air flow path 7x, are inevitably determined when the shapes of the flow paths 71x, 72x, and 73x are determined. Therefore, here, the shapes of the flow paths 71x, 72x, and 73x will be described.

As for the flow path 71x, the spacer 3 is shaped so as to have a bilaterally symmetrical trapezoidal shape in which two legs have the same length, that is, an isosceles trapezoidal shape. However, a lower base is constituted not by the spacer 3 but by the partition plate 2. An upper base of the isosceles trapezoidal shape corresponds to the protrusion 31b of the spacer 3, and the protrusion 31b is bonded to the partition plate 2 on the upper side with an adhesive 4. When an angle formed between the partition plate 2 on the lower side and the side wall 32 which is a left leg constituting the flow path 71x is denoted by θ1, and an angle formed between the partition plate 2 on the lower side and the side wall 32 which is a right leg constituting the flow path 71x is denoted by θ2, θ1≈θ2 holds. That is, θ1 and θ2 coincide with each other within the margin of error. As described above, the flow path 71x has a bilaterally symmetrical isosceles trapezoidal shape including two legs of equal length.

A lower part of the right leg constituting the flow path 71x corresponds to the recess 31a of the spacer 3, and the recess 31a is bonded to the partition plate 2 on the lower side with the adhesive 4. In one example, the recess 31a is bonded in a length as same as that of the bonding portion of the protrusion 31b. The adhesive 4 as the bonding portion is interposed, and the flow path 72x is provided below the spacer 3. The flow path 72x is constituted by shaping the spacer 3 so as to have a bilaterally asymmetrical trapezoidal shape in which a left leg is longer than the left leg of the flow path 71x, and a right leg has substantially the same length as the leg of the flow path 71x. However, a lower base is constituted not by the spacer 3 but by the partition plate 2. The protrusion 31b of the spacer 3 located at the upper base of the trapezoidal shape is bonded to the partition plate 2 on the upper side with the adhesive 4. When an angle formed between the partition plate 2 on the lower side and the left leg constituting the flow path 72x is denoted by θ3, and an angle formed between the partition plate 2 on the lower side and the right leg constituting the flow path 72x is denoted by θ4, θ3<θ1 and θ4≈θ2 hold. As described above, the flow path 72x has a bilaterally asymmetrical trapezoidal shape including two legs of different lengths.

A lower part of the right leg constituting the flow path 72x corresponds to the recess 31a of the spacer 3, and the recess 31a is bonded to the partition plate 2 on the lower side with the adhesive 4. In one example, the recess 31a is bonded in a length as same as that of the bonding portion of the protrusion 31b. The adhesive 4 as the bonding portion is interposed, and the flow path 73x is provided below the spacer 3. The flow path 73x is constituted by shaping the spacer 3 so as to have a bilaterally asymmetrical trapezoidal shape in which a left leg has substantially the same length as the left leg of the flow path 71x, and the right leg is longer than the right leg of the flow path 71x. However, a lower base is constituted not by the spacer 3 but by the partition plate 2. The protrusion 31b of the spacer 3 located at the upper base of the trapezoidal shape is bonded to the partition plate 2 on the upper side with the adhesive 4. When an angle formed between the partition plate 2 on the lower side and the left leg constituting the flow path 73x is denoted by θ5, and an angle formed between the partition plate 2 on the lower side and the right leg constituting the flow path 73x is denoted by θ6, θ6<θ2 and θ5≈θ1 hold. As described above, the flow path 73x has a bilaterally asymmetrical trapezoidal shape including two legs of different lengths.

The bilaterally asymmetrical trapezoidal shape of the flow path 72x is a shape substantially equal to the bilaterally asymmetrical trapezoidal shape of the flow path 73x when inverted in the left-right direction. When the flow path 71x is inverted in the vertical direction, the shape thereof becomes a shape substantially equal to that of the flow path 74x, when the flow path 72x is inverted in the vertical direction, the shape thereof becomes a shape substantially equal to that of the flow path 75x, and when the flow path 73x is inverted in the vertical direction, the shape thereof becomes a shape substantially equal to that of the flow path 76x. Since the structures of the respective flow paths 71y, 72y, 73y, 74y, 75y, and 76y constituting the second intra-element air flow path 7y are the same as the structures of the respective flow paths 71x, 72x, 73x, 74x, 75x, and 76x constituting the first intra-element air flow path 7x, the descriptions thereof will be omitted.

When attention is paid to a trapezoidal flow path formed between the spacer 3 and the partition plate 2 on the lower side, in the case of the first embodiment, the flow path 71x having an isosceles trapezoidal shape and the flow paths 72x and 73x each having a bilaterally asymmetrical trapezoidal shape are repeating units. Therefore, a resultant obtained by arranging three trapezoidal flow paths in the left-right direction is employed as a repeating unit. In a conventional total heat exchange element, a spacer has a structure shaped such that isosceles trapezoidal flow paths inverted upside down are alternately and repeatedly arranged in the left-right direction. The repeating unit in the total heat exchange element 1 of the first embodiment includes the flow paths 72x and 73x each having a bilaterally asymmetrical trapezoidal shape including a leg longer than the leg of the flow path 71x having a bilaterally symmetrical trapezoidal shape, so that the length of the repeating unit in the left-right direction is long as compared with a case where three trapezoidal flow paths are repeatedly arranged in such a conventional total heat exchange element. As a result, when the spacer 3 is bonded to the partition plate 2, the number of repeating units included in the partition plate 2 is small in the case of the first embodiment as compared with conventional cases. That is, the number of bonding portions where the partition plate 2 and the spacer 3 are bonded by the adhesive 4 is small in the case of the first embodiment as compared with conventional cases. In each bonded portion, moisture permeability is poor due to the presence of the adhesive 4, and thus humidity exchange efficiency is low. However, since the number of bonding portions is small in the case of the first embodiment as compared with the conventional cases, the humidity exchange efficiency can be improved. In addition, since the flow path 71x having an isosceles trapezoidal shape is included in a predetermined ratio or more and the flow paths 71x having an isosceles trapezoidal shape are arranged to be periodically located, it is possible to form the intra-element air flow path 7 and to maintain the strength for maintaining the shape.

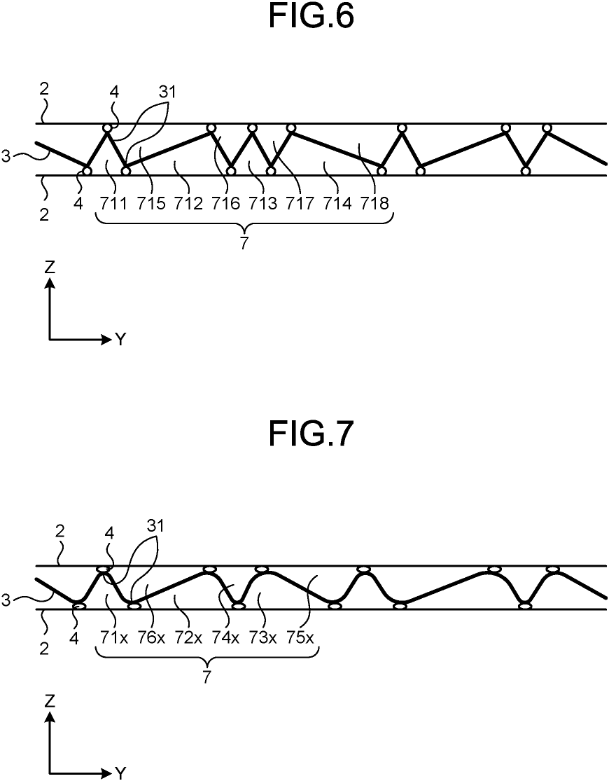

In the examples of FIGS. 4 and 5, the case where the flow paths 71x, 72x, 73x, 74x, 75x, 76x, 71y, 72y, 73y, 74y, 75y, and 76y each have a trapezoidal shape is illustrated. However, the shape of each flow path is not limited to the trapezoidal shape, and it is only required that a bilaterally symmetrical shape and a bilaterally asymmetrical shape be mixed. FIG. 6 is a cross-sectional view schematically illustrating another example of a configuration of an air flow path of the total heat exchange element according to the first embodiment. The same components as those in FIG. 4 are denoted by the same reference numerals, and in the example of FIG. 6, the intra-element air flow path 7 includes flow paths 711, 712, 713, 714, 715, 716, 717, and 718 each having a triangular cross-sectional shape. In that case, the apexes 31 of the spacer 3 constituting the flow paths 711, 712, 713, 714, 715, 716, 717, and 718 each having a triangular shape are bonded to the partition plate 2 by the adhesive 4. Among them, the flow paths 711, 713, 716, and 717 each have a bilaterally symmetrical isosceles triangular shape, and the flow paths 712, 714, 715, and 718 each have a bilaterally asymmetrical triangular shape.

FIG. 7 is a cross-sectional view schematically illustrating another example of a configuration of an air flow path of the total heat exchange element according to the first embodiment. The same components as those in FIG. 4 are denoted by the same reference numerals, and the descriptions thereof will be omitted. In the example of FIG. 7, the apexes 31 of the upper bases and the lower bases in FIGS. 4 and 5 are constituted with curves. Therefore, in FIG. 4, the flow paths 71x, 72x, 73x, 74x, 75x, and 76x each have a trapezoidal shape, but in FIG. 7, each vertex portion is constituted with a curve and has a rounded triangular shape. Also in that case, the apexes 31 each constituted with a curve are bonded to the partition plate 2 by the adhesive 4.

Next, attention is paid to pressure losses in the first intra-element air flow path 7x and the second intra-element air flow path 7y. For the total heat exchange element 1, the lower the pressure loss, the more advantageous in performance. The pressure loss is basically related to a wind speed at which air passes through a flow path, or the shape or size of a cross section of the flow path, that is, an equivalent diameter of circular tube. Here, the equivalent diameter of circular tube is a characteristic length indicating a diameter of circular tubes, being equivalent to the cross section of the flow path.

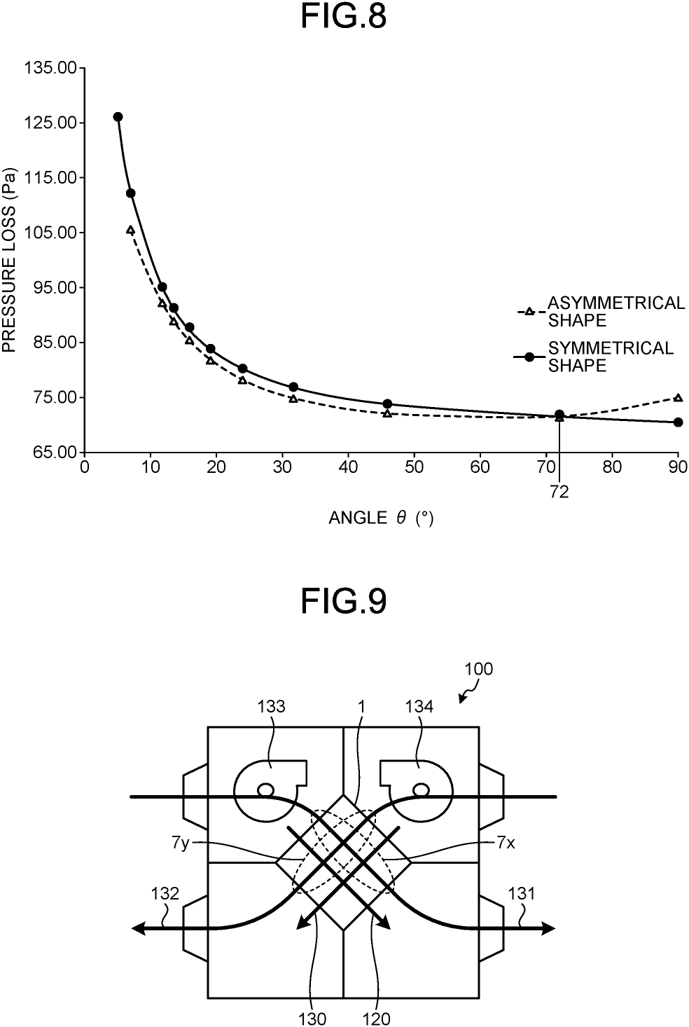

FIG. 8 is a diagram illustrating an example of a relationship between pressure loss and an angle formed between a lower base and a leg of a trapezoid in each of a flow path having a bilaterally symmetrical trapezoidal shape and a flow path having a bilaterally asymmetrical trapezoidal shape. Illustrated here is a result of calculation of the relationship between pressure loss in each of a flow path having a bilaterally symmetrical trapezoidal shape and a flow path having a bilaterally asymmetrical trapezoidal shape and an angle θ formed between a lower base and a leg of each trapezoidal flow path, the calculation being made by performing conversion into an equivalent diameter. The flow path having a bilaterally symmetrical trapezoidal shape is, for example, a flow path in which two legs have the same length and θ1≈θ2 holds, as in the flow paths 71x and 74x in FIG. 4. The flow path having a bilaterally asymmetrical trapezoidal shape is, for example, a flow path in which two legs have different lengths and θ3≠θ4 or θ5≠θ6 holds, as in the flow paths 72x, 73x, 75x, and 76x in FIG. 4. In FIG. 8, the horizontal axis represents an angle θ [°] between a lower base and a leg of each flow path, and the vertical axis represents pressure loss [Pa] in each flow path.

As illustrated in FIG. 8, the pressure loss is low when θ is in a range of more than 30° and 90° or less. Furthermore, it can be seen that, in a case where θ is in a range of 72° or less, the pressure loss is lower in flow paths having a bilaterally asymmetrical trapezoidal shape than in flow paths having a bilaterally symmetrical trapezoidal shape. That is, the pressure loss in an air flow path of the total heat exchange element 1 can be reduced by including a flow path having a bilaterally asymmetrical shape in the air flow path. In addition, it can be seen that, in order to reduce the pressure loss, the angle θ between the lower base and the leg of each trapezoidal flow path is desirably larger than 30° and equal to or smaller than 72°. The same applies even if the flow paths each have a triangular shape as illustrated in FIG. 6 or a shape including a curve as illustrated in FIG. 7. That is, the same applies to the intra-element air flow path 7 including a flow path having a shape which is line-symmetrical with respect to a straight line parallel to the Z direction and a flow path having a shape which is not line-symmetrical with respect to a straight line parallel to the Z direction.

FIG. 9 is a view schematically illustrating an example of a configuration of a ventilator according to the first embodiment. In FIG. 9, a ventilator 100 includes the total heat exchange element 1 described above. The ventilator 100 illustrated in FIG. 9 is installed in a house or the like, and is used as a heat exchange ventilator that performs heat exchange between indoor air and outdoor air.

As illustrated in FIG. 9, the ventilator 100 according to the first embodiment includes therein: a supply air flow path 131 which is a first air flow path for supplying outdoor air into a room; and an exhaust air flow path 132 which is a second air flow path for exhausting indoor air outside the room. The total heat exchange element 1 is arranged in the middle of the supply air flow path 131 and the exhaust air flow path 132. Therefore, a part of the supply air flow path 131 includes the first intra-element air flow path 7x of the total heat exchange element 1, and a part of the exhaust air flow path 132 includes the second intra-element air flow path 7y of the total heat exchange element 1.

The ventilator 100 includes: a supply air blower 133 that is provided in the supply air flow path 131 and generates a flow of air from the outside toward the inside of the room; and an exhaust air blower 134 that is provided in the exhaust air flow path 132 and generates a flow of air from the inside toward the outside of the room.

When operation of the ventilator 100 is started, the supply air blower 133 and the exhaust air blower 134 are operated. For example, assuming that it is winter, cool and dry outdoor air passes through the first intra-element air flow path 7x as the first air flow 120 which is a supply air flow, and warm and humid indoor air passes through the second intra-element air flow path 7y as the second air flow 130 which is an exhaust air flow. Respective air flows of the supply air flow and the exhaust air flow, that is, two types of air flows separately flow with the partition plate 2 therebetween. At that time, heat is transferred between the respective air flows via the partition plate 2, and water vapor passes through the partition plate 2, and thereby heat exchange of sensible heat and latent heat is performed between the supply air flow and the exhaust air flow. As a result, the supply air flow is warmed, humidified, and supplied into the room; and the exhaust air flow is cooled, dehumidified, and discharged outside the room. Accordingly, the ventilation by the ventilator 100 makes it possible to replace indoor air with outdoor air while suppressing changes in temperature and humidity in the room.

As described above, in the total heat exchange element 1 according to the first embodiment, the intra-element air flow path 7 is formed of: the flow path 71 having a bilaterally symmetrical shape including two legs of the same length; and the flow paths 72 and 73 each having a bilaterally asymmetrical shape including two legs one of which is longer than the leg of the flow path 71 having a bilaterally symmetrical shape. Therefore, the strength in the stacking direction can be ensured by the flow path 71 having a bilaterally symmetrical shape, and the number of bonding portions between the partition plate 2 and the spacer 3 is reduced by the flow paths 72 and 73 each having a bilaterally asymmetrical shape, so that humidity exchange efficiency as the total heat exchange element 1 can be improved and the total heat exchange efficiency can be improved.

In addition, the strength of the total heat exchange element 1 becomes uniform as a whole by sequentially and repeatedly arranging the flow path 71 having a bilaterally symmetrical shape and the flow paths 72 and 73 each having a bilaterally asymmetrical shape, and the strength of the total heat exchange element 1 can be ensured. Furthermore, in addition to the above effect, the pressure loss of the intra-element air flow path 7 can also be reduced by setting the angle θ between the side wall 32 of the spacer 3 and the partition plate 2 to be larger than 30° and equal to or smaller than 72°.

The configurations described in the embodiment above are merely examples and can be combined with other known technology and part of the configurations can be omitted or modified without departing from the gist thereof.

### Reference Signs List

1 total heat exchange element; 2 partition plate; 3 spacer; 4 adhesive; 5 unit component; 7 intra-element air flow path; 7x first intra-element air flow path; 7y second intra-element air flow path; 31 apex; 31a recess; 31b protrusion; 32 side wall; 51 ventilation surface; 71, 71x, 71y, 72, 72x, 72y, 73, 73x, 73y, 74x, 74y, 75x, 75y, 76x, 76y, 711, 712, 713, 714, 715, 716, 717, 718 flow path; 100 ventilator; 120 first air flow; 130 second air flow; 131 supply air flow path; 132 exhaust air flow path; 133 supply air blower; 134 exhaust air blower.

1. A total heat exchange element including partition plates, and spacers shaped into a corrugated shape in which a plurality of apexes including recesses and protrusions are connected by side walls, the partition plates and the spacers being stacked such that extending directions of the plurality of apexes intersect between the spacers adjacent to each other, wherein
the total heat exchange element includes, between two of the partition plates adjacent in the stacking direction, a plurality of flow paths surrounded by the partition plates and the side walls,
the plurality of flow paths include flow paths each having a shape that is line-symmetrical with respect to a straight line extending in the stacking direction, and flow paths each having a shape that is not line-symmetrical with respect to a straight line extending in the stacking direction, and
a length of the side walls constituting the flow paths each having a shape that is not line-symmetrical is longer than a length of the side walls constituting the flow paths each having a shape that is line-symmetrical.

2. The total heat exchange element according to claim 1, wherein regarding the plurality of flow paths, the flow paths each having a shape that is line-symmetrical and the flow paths each having a shape that is not line-symmetrical are regularly and repeatedly arranged along an alignment direction of the plurality of apexes.

3. The total heat exchange element according to claim 1, wherein an angle at which the side walls intersect the partition plates is larger than 30° and equal to or smaller than 90°.

4. The total heat exchange element according to claim 1, wherein an angle at which the side walls intersect the partition plates is larger than 30° and equal to or smaller than 72°.

5. The total heat exchange element according to claim 1, wherein the plurality of flow paths have a trapezoidal shape, a triangular shape, or a triangular shape in which each vertex portion is constituted with a curve.

6. A ventilator comprising:
a first blower adapted to flow a first air flow through a first air flow path;
a second blower adapted to flow a second air flow through a second air flow path; and
the total heat exchange element according to claim 1, arranged in the middle of the first air flow path and the second air flow path.

7. The total heat exchange element according to claim 2, wherein an angle at which the side walls intersect the partition plates is larger than 30° and equal to or smaller than 90°.

8. The total heat exchange element according to claim 2, wherein an angle at which the side walls intersect the partition plates is larger than 30° and equal to or smaller than 72°.

9. The total heat exchange element according to claim 2, wherein the plurality of flow paths have a trapezoidal shape, a triangular shape, or a triangular shape in which each vertex portion is constituted with a curve.

10. The total heat exchange element according to claim 3, wherein the plurality of flow paths have a trapezoidal shape, a triangular shape, or a triangular shape in which each vertex portion is constituted with a curve.

11. The total heat exchange element according to claim 7, wherein the plurality of flow paths have a trapezoidal shape, a triangular shape, or a triangular shape in which each vertex portion is constituted with a curve.

12. The total heat exchange element according to claim 4, wherein the plurality of flow paths have a trapezoidal shape, a triangular shape, or a triangular shape in which each vertex portion is constituted with a curve.

13. The total heat exchange element according to claim 8, wherein the plurality of flow paths have a trapezoidal shape, a triangular shape, or a triangular shape in which each vertex portion is constituted with a curve.

14. A ventilator comprising:
a first blower adapted to flow a first air flow through a first air flow path;
a second blower adapted to flow a second air flow through a second air flow path; and
the total heat exchange element according to claim 2, arranged in the middle of the first air flow path and the second air flow path.

15. A ventilator comprising:
a first blower adapted to flow a first air flow through a first air flow path;
a second blower adapted to flow a second air flow through a second air flow path; and
the total heat exchange element according to claim 3, arranged in the middle of the first air flow path and the second air flow path.

16. A ventilator comprising:
a first blower adapted to flow a first air flow through a first air flow path;
a second blower adapted to flow a second air flow through a second air flow path; and
the total heat exchange element according to claim 4, arranged in the middle of the first air flow path and the second air flow path.

17. A ventilator comprising:
a first blower adapted to flow a first air flow through a first air flow path;
a second blower adapted to flow a second air flow through a second air flow path; and
the total heat exchange element according to claim 5, arranged in the middle of the first air flow path and the second air flow path.
